(19) United States
(12) Patent Application Publication
(10) Pub. No.: US 2012/0018005 A1
(43) Pub. Date: Jan. 26, 2012

(54) COUPLING DEVICE FOR CONNECTING THE TWO HALF-SHELLS OF AN AIRCRAFT ENGINE NACELLE, AND NACELLE EQUIPPED WITH SUCH A DEVICE

(75) Inventors: Pascal Soulier, Le Havre (FR); Aurelie De Sorbay, Le Havre (FR)

(73) Assignee: AIRCELLE, Gonfreville L'Orcher (FR)

(21) Appl. No.: 12/674,181

(22) PCT Filed: Jun. 20, 2008
(86) PCT No.: PCT/FR08/00863

§ 371 Date: Feb. 19, 2010

(30) Foreign Application Priority Data
Aug. 20, 2007 (FR) 0705902

(51) Int. Cl. F02C 7/04; F16B 1/00

(52) U.S. Cl. 137/15.1; 403/315

(57) ABSTRACT

Coupling device for connecting the two half-shells (1′) of an aircraft engine nacelle, comprising a connecting rod (17) which can be mounted in an articulated manner on one (1′) of the two half-shells, a retention member for this connecting rod (17) that can be mounted on the other half-shell, and means designed to allow limited movements of said connecting rod with respect to said retention member.

### TECHNICAL FIELD

The present invention relates to a coupling device for connecting the two half-shells of an aircraft engine nacelle, and to a nacelle equipped with such a device.

### BACKGROUND

As is known per se, an aircraft engine nacelle is the structure surrounding this engine and notably channeling the air toward this engine.

A nacelle such as this typically comprises at least two half-shells mounted articulated on a pylon about axes substantially parallel to the axis of the nacelle.

The pylon is itself intended to be fixed under the wing of an aircraft.

Articulating the two half-shells to this pylon allows these half-shells to be opened up in order to provide access to the engine for maintenance operations.

During flight, these two half-shells are subjected to significant stresses due mainly to the pressures generated by the flow of air over these half-shells.

The coupling means connecting the two half-shells constitute bridges through which the loads generated particularly by these pressures are transmitted.

Thus, both these coupling means and the regions of these half-shells located near these coupling means need to be reinforced.

Such reinforcements increase the weight and complexity and are therefore disadvantages that need to be addressed.

### BRIEF SUMMARY

The disclosure provides a coupling device for connecting the two half-shells of an aircraft engine nacelle, comprising a link rod able to be mounted articulated on one of the two half-shells, a retaining member for this link rod able to be mounted on the other half-shell, and means able to allow limited movements of said link rod with respect to said retaining member.

By virtue of the presence of these means that allow limited movements of the link rod with respect to the retaining member, limited movements between the two half-shells can be permitted, the coupling means then becoming active only if the two half-shells are pulled or pushed over significant distances.

It will therefore be appreciated that the coupling device according to the invention works on a principle of allowing limited relative movements of the two half-shells rather than of immobilizing these two shells with respect to one another, thus making it possible to eliminate a proportion of the forces generated by the pressures due to the flow of air over these half-shells.

It is possible in that way to minimize the design of these two half-shells, particularly in the region where these coupling means are located, making it possible to reduce the weight and complexity of the whole.

According to other optional features of the present invention, considered alone or in combination:

said means of limited movement comprise an oblong slot formed in the free end of said link rod, and a pin integral with said retaining means, this slot and this pin between them defining play in both senses of the direction of said link rod: coupling means that allow limited movements are thus produced in a simple way;

said play is in a range from 5 to 25 mm and preferably from 10 to 20 mm: this play generally corresponds to the permitted tolerances for relative movements of the two half-shells;

said link rod has a length of between 50 and 1000 mm.

The present invention also relates to an aircraft nacelle comprising two half-shells articulated in their upper parts to a pylon, comprising at least one coupling device for connecting the two half-shells in accordance with the foregoing.

According to other optional features of this nacelle:

said device is placed in the upper forward part, in the upper rear part and in the lower forward part of said half-shells: this device thus supplements the locking devices positioned in the lower part of the nacelle;

said device is mounted on panels of the inner structure of said nacelle;

said half-shells are provided with thrust-reversal means;

said half-shells define a plain nacelle;

said device comprises actuating means positioned in the lower part of said nacelle.

### BRIEF DESCRIPTION OF THE DRAWINGS

Further features and advantages of the present invention will become apparent in the light of the description which will follow, and from examining the attached figures in which:

FIG. 1 is a perspective view of a right-hand half-shell of a nacelle according to the invention;

FIG. 2 is a perspective view of a left-hand half-shell of a nacelle according to the invention;

FIG. 3 is a perspective view, to a larger scale, of the link rod of the coupling device according to the invention;

FIG. 4 is a view from above of the region in which the coupling device collaborates with the right-hand half-shell of FIG. 1; and

FIG. 5 schematically depicts the coupling device according to the invention, interposed between the right-hand and left-hand half-shells of FIGS. 1 and 2 respectively.

### DETAILED DESCRIPTION

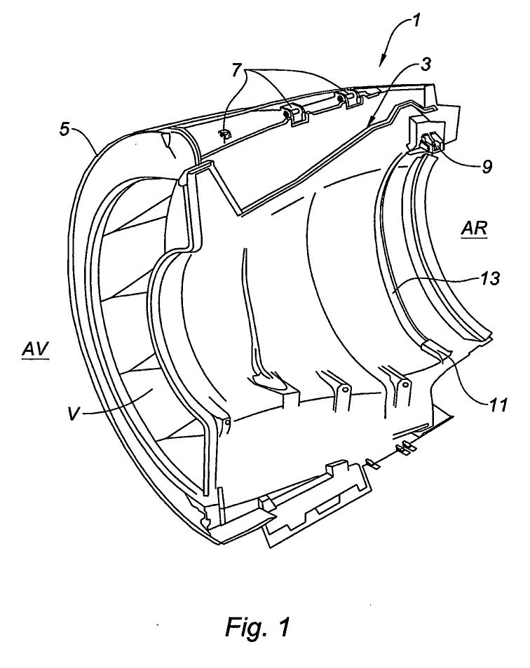

Reference is made to FIG. 1 which shows a right-hand half-shell 1 of a nacelle, which in this instance is intended to be positioned to the rear of a nacelle, and constitutes part of a thrust reverser device (it being understood that the invention also applies to the case of a plain nacelle, that is to say one that has no thrust-reversal means).

The references AV and AR respectively denote the forward and rear parts of the half-shell 1, with respect to the direction of the flow of air intended to flow inside this half-shell 1.

In this particular instance, this half-shell 1 comprises an inner half-structure 3, defining a half-cavity C intended to house a jet engine (not depicted).

This half-shell 1 also comprises an outer structure 5 which, with the inner structure 3, defines a half-flow path V through which a flow of cold air flowing between the front and the rear of the half-shell 1 is intended to travel.

In its upper part, that is to say in its part intended to be positioned toward the top when this half-shell 1 is mounted under the wing of an aircraft, this half-shell comprises several articulation points 7 designed to allow this half-shell 1 to be mounted on the pylon (or strut) of an aircraft wing (not depicted).

In its upper rear part, the inner half-structure 3 comprises a retaining member 9 the purpose of which will be explained later on.

This retaining member 9 may be actuated by a control knob 11 situated in the lower rear part of the half-shell 1, movement-transmitting means such as cables 13 being laid between the knob 11 and the member 9.

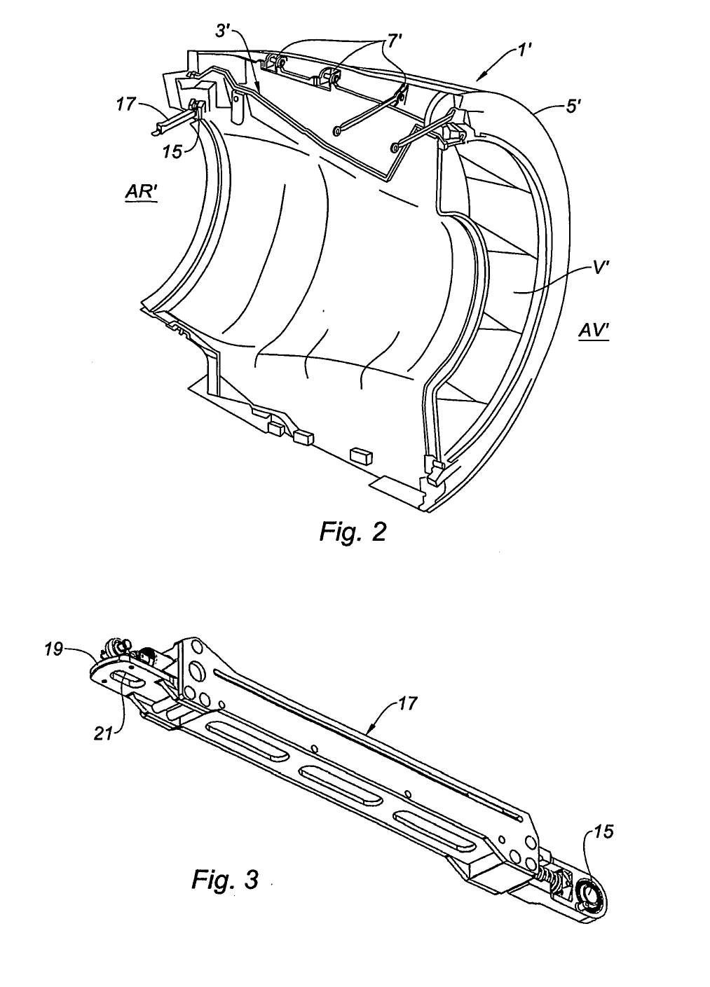

The left-hand half-shell depicted in FIG. 2 complements the half-shell 1 depicted in FIG. 1, and those members of this left-hand half-shell which are analogous to those of the half-shell 1 bear identical references, followed by a prime symbol (′).

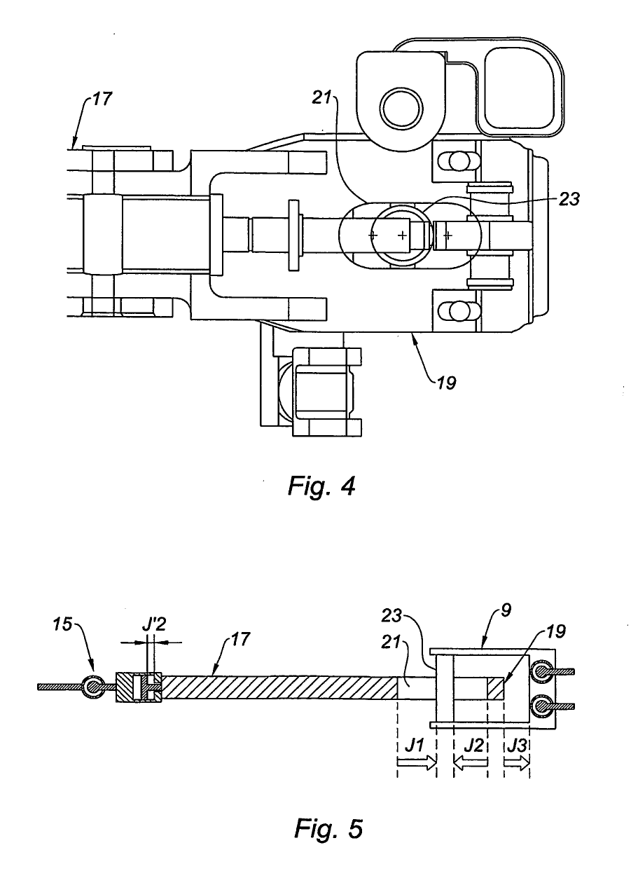

In its upper rear part, the inner half-structure 3′ of the half-shell 1′ has a point 15 of attachment of a link rod 17 visible notably in FIGS. 3 and 4.

This link rod 17 is mounted with a ball joint connection (or possibly with a simple pivot joint depending on the type of nacelle and on the location of the coupling) on the mounting point 15, and at its free end 19 comprises a female part 21 able to collaborate with the retaining member 9 situated on the right-hand half-shell 1 and defining a male part.

More specifically, as may be seen in FIGS. 3 to 5, the female part 21 comprises an oblong slot formed in the free end 19 of the link rod 17.

The male part of the retaining member 9 comprises a pin 23 able to pass through the oblong slot 21.

As may be seen in FIG. 5, the pin 23 with the oblong slot 21 defines play J1 and J2 in both senses of the direction in which the link rod 17 extends, and play J3 with respect to the closed end of the retaining member 9.

By way of indication, the play J1, J2 and J3 may fall in a range from 5 to 25 mm, and preferably in a range from 10 to 20 mm.

The link rod may have a length of between 50 and 1000 mm, depending on where it is installed (at the front, in the middle, or at the rear of the nacelle, at the top (in the 12 o'clock position) or at the bottom (in the 6 o'clock position)). By way of example, in the case of the Airbus A380, the length of this link rod ranges between 100 and 800 mm.

The way in which the coupling device includes the link rod 17 and of the retaining member 9 works and the advantages it affords are directly evident from the foregoing description.

The link rod 17 is mounted articulated in a permanent manner on the left-hand half-shell 1′.

By contrast, the free end 19 of this link rod 17 is mounted disengagably on the retaining member 9 of the right-hand half-shell 1.

More specifically, in a normal operating situation, the right-hand 1 and left-hand 1′ half-shells are closed around the jet engine situated inside the half-cavities C and C′, thus defining an assembly of substantially cylindrical shape.

A number of latches positioned in the lower parts of the half-shells 1 and 1′ secure these two half-shells to one another.

The pin 23 of the retaining member 9 passes through the oblong slot 21 of the free end 19 of the link rod 17, thus securing the upper rear parts of the inner half-structures 3 and 3′ of the half-shells 1 and 1′ to one another.

Because of the play J1, J2, J3, the link rod 17 can move slightly in both senses of its direction with respect to the retaining member 9, and this therefore allows a small relative movement of the two inner half-structures 3 and 3′ under the effect of loads due mainly to the flow of air over the half-shells.

By contrast, if these two inner half-structures were subjected to significant pulling or pushing loads, the oblong slot 21 of the link rod 17 would come into abutment against the pin 23 of the retaining member 9, under tension or compression respectively. In that way, excessive relative movements of the two inner half-structures 3 and 3′ are prevented, making it possible to maintain the integrity of these half-structures in the event of significant stresses.

As mentioned previously, the play permitted for the link rod 17 with respect to the retaining member 9 makes it possible to dispense with reinforcing members, particularly in the regions of the inner half-structures 3 and 3′ situated near the link rod 17, making it possible to simplify and lighten these two half-structures.

It must also be noted that, in practice, a coupling device like the one described hereinabove operates more (in practically all the flights) in compression than in tension (just some flights): there is therefore no need for this device to be designed for fatigue, and this once again adds to the weight saving.

It must also be noted that if the play J3 is made to be greater than the play J1, the pin 23 is not loaded in compression, and force is reacted directly by the link rod; because this pin is thus less heavily loaded, it is possible to reduce its size, and thus save weight.

It must also be noted that play J′2 may be provided in that part of the link rod 17 that lies in close proximity to the mounting point 15 (see FIG. 5): such play allows the link rod an extended travel in tension once the play J2 has been used up.

When there is a desire to access the jet engine situated inside the two half-cavities C and C′, the actuating knob 11 situated on the right-hand half-shell 1 is operated to release the pin 23 from the oblong slot 21, and this (once all the latches situated in the lower part of the two half-shells have also been opened) allows the two half-shells 1 and 1′ to be opened outward by pivoting them about axes that pass through the articulation points 7 and 7′.

In that way, it is possible to have free access to the aircraft jet engine.

Of course, the present invention is not in any way restricted to the embodiment described and depicted, which has been provided simply by way of example.

Thus, for example, it is also possible to conceive of positioning a coupling device like the one described hereinabove in the upper forward and lower forward parts of the two half-shells.

1. A coupling device for connecting two half-shells of an aircraft engine nacelle, comprising:
a link rod able to be mounted articulated on one of the two half-shells,
a retaining member for this link rod able to be mounted on the other half-shell, and
means able to allow limited movements of said link rod with respect to said retaining member.

2. The device as claimed in claim 1, in which said means of limited movement comprise an oblong slot formed in a free end of said link rod, and a pin integral with said retaining means, the slot and the pin between them defining a play in both senses of a direction of said link rod.

3. The device as claimed in claim 2, in which said play is in a range from about 5 to 25 mm.

4. The device as claimed in claim 1, in which said link rod has a length of between about 50 and 1000 mm.

5. An aircraft nacelle comprising two half-shells articulated in upper parts to a pylon, comprising at least one coupling device for connecting the two half-shells as claimed in claim 1.

6. The nacelle as claimed in claim 5, in which said device is placed in an upper forward part, in an upper rear part and in a lower forward part of said half-shells.

7. The nacelle as claimed in claim 5, in which said device is mounted on panels of a inner structure of said nacelle.

8. The nacelle as claimed in claim 5, in which said half-shells are provided with thrust-reversal means.

9. The nacelle as claimed in claim 5, in which said half-shells define a plain nacelle.

10. The nacelle as claimed in claim 5, in which said coupling device comprises actuating means positioned in the lower part of said nacelle.

11. The device as claimed in claim 3, in which said play is in a range from about 10 to 20 mm.
